(19) United States
(12) Patent Application Publication
(10) Pub. No.: US 2019/0176295 A1
(43) Pub. Date: Jun. 13, 2019

(54) VACCUM ABSORBING PLATFORM

(71) Applicant: HIWIN MIKROSYSTEM CORP., Taichung City (TW)

(72) Inventors: Bo-Yuan CHEN, Taichung City (TW); Yun-Wei LIN, Taichung City (TW); Feng-Xiang WANG, Taichung City (TW)

(21) Appl. No.: 15/837,706

(22) Filed: Dec. 11, 2017

(51) Int. Cl. B25B 11/00

(52) U.S. Cl. CPC B25B 11/005

(57) ABSTRACT

A vacuum absorbing platform, having contiguously a base and a plate unit disposed on the base and having a body, a front panel and a rear panel. The body has a plurality of cells contiguous with each other and a plurality of first openings configured on the walls of the cells. The front panel is secured on one side of the body to seal the cells and has a plurality of voids communicate with the cells respectively. The rear panel is secured on the other side of the body to seal the cells. A plurality of adjusters are located between the base and the plate unit to regulate the distance therebetween.

### BACKGROUND OF THE INVENTION

### Field of the Invention

The invention relates to a platform, and more particularly to a vacuum absorbing platform.

### Description of the Related Art

Refer to FIG. 1. The conventional vacuum absorbing platform (1) includes a honeycombed core (2) secured between the front panel (3) and the rear panel (4) wherein the holes (3a) of the front panel (3) correspond to the holes (4a) of the rear panel (4). The holes (3a) (4a) link with the cells (2a) of the honeycombed core (2) to form a plurality of voids, and the space of the frame (5) is associated with the voids. Therefore, the air within the space of the frame (5) is drawn through the exterior aspirator to provide a negative pressure in the honeycombed core (2) thereby absorbing and securing the workpiece.

Regarding to the above conventional structure, the holes (3a) (4a) must be positioned at the opposite ends of each cell (2a) such that the assembly process is inconvenient and complicated. Moreover, the air within the space of the frame (5) cannot be drawn when the holes (4a) of the rear panel (4) are blocked, and the absorbing effect is decreased.

### SUMMARY OF THE INVENTION

In view of the disadvantages of prior art, the object of the present invention is to provide a vacuum absorbing platform with a plurality of cells communicated with each other laterally to prevent the air from being blocked and increase the absorbing effect.

To achieve the above object, the present invention provides a vacuum absorbing platform comprising a base, a plate unit and a plurality of adjusters. The plate unit is disposed on the base and comprises a body, a front panel and a rear panel. The body comprises a plurality of cells configured with each other and a plurality of first openings configured on the walls of the cells. The front panel is secured on one side of the body to seal the cells and comprises a plurality of voids communicate with the cells respectively. The rear panel is secured on the other side of the body to seal the cells. The adjusters are located between the base and the plate unit to regulate the distance therebetween.

In one embodiment of the present invention, the vacuum absorbing platform comprises a connector with a connecting division and a plurality of second openings. The connecting division is arranged between the plates, and the second openings are configured on the connecting division and communicated with the first openings.

In one embodiment of the present invention, each of the adjusters comprises a fixture, a mover, an adjusting element and an elastic element. The fixture is secured on the base. The mover is positioned through the body and connected with the front panel. The adjusting element is connected between the fixture and the mover, and the elastic element is set between the fixture and the mover.

In one embodiment of the present invention, the elastic element is a helical spring holding the adjusting element.

In one embodiment of the present invention, the adjusting element is locked within the screw hole of the fixture.

In one embodiment of the present invention, the base comprises a plurality of hollow tubes crossed with each other wherein the foam material is fulfilled with the hollow tubes.

In one embodiment of the present invention, the base comprises a plurality of strengthening elements secured on the intersections of the hollow tubes.

In one embodiment of the present invention, each of the strengthening elements comprises a first shell, a second shell, a first supporter and a second supporter. The first shell and the second shell are assembled with each other to hold the intersection of the hollow tubes. The first supporter is fixed on the first shell, and the second supporter is fixed on the second shell. The first supporter is set against the second supporter.

### BRIEF DESCRIPTION OF THE DRAWINGS

FIG. 1 is a schematic view of the conventional vacuum absorbing platform;

FIG. 2 is a schematic view of the vacuum absorbing platform according to the embodiment of the present invention;

FIG. 3 is a partial exploded view of the vacuum absorbing platform according to the embodiment of the present invention;

FIG. 4 is a partial exploded view of the base according to the embodiment of the present invention;

FIG. 5 is an exploded view of the plate according to the embodiment of the present invention;

FIG. 6 is a partial enlarged schematic view of the body according to the embodiment of the present invention;

FIG. 7 is a partial cross sectional view of the vacuum absorbing platform along the line 7-7 of FIG. 2;

FIG. 8 is an exploded view of the adjuster according to the embodiment of the present invention; and

FIG. 9 is a cross sectional view of the vacuum absorbing platform along the line 9-9 of FIG. 2;

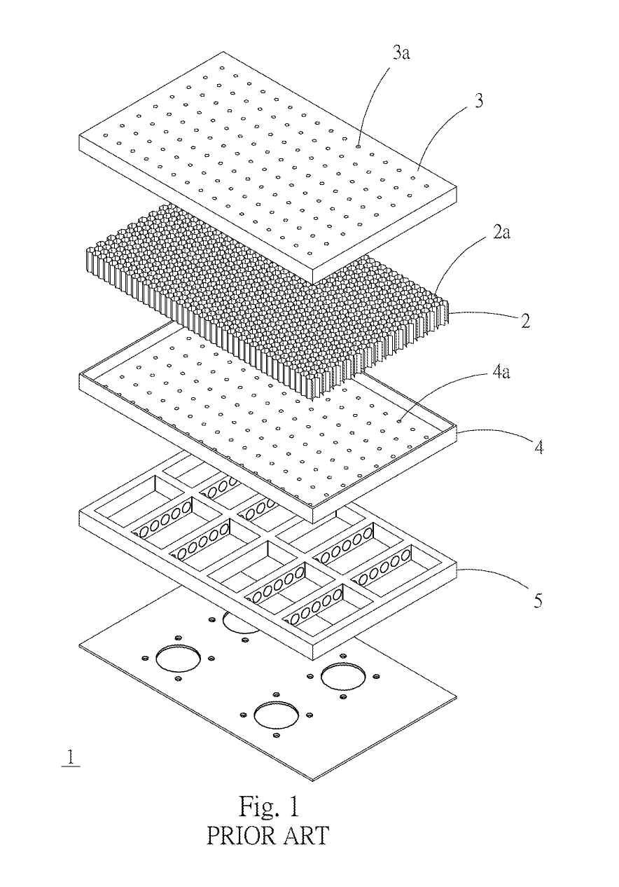

### DETAILED DESCRIPTION OF THE PREFERRED EMBODIMENTS

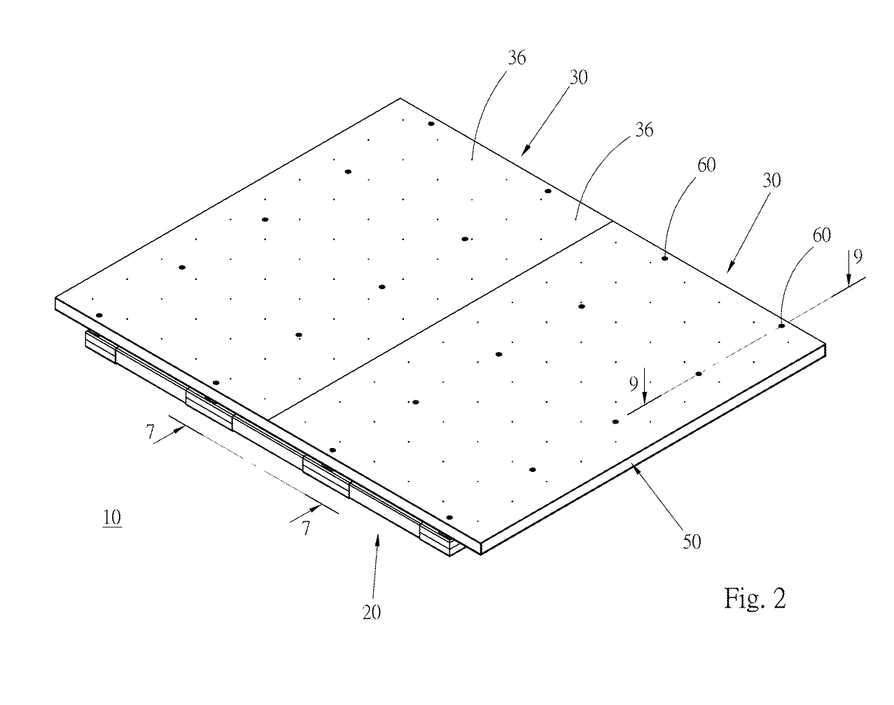

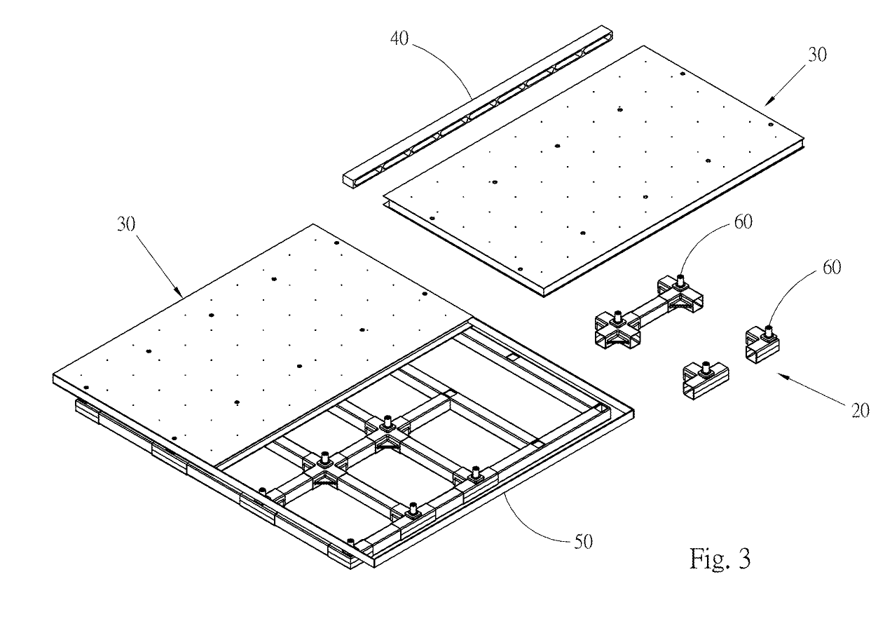

Refer to FIG. 2 and FIG. 3. The vacuum absorbing platform 10 includes a base 20, two plates 30, a connector 40, a border 50 and a plurality of adjusters 60. The connector 40 is arranged between the plates 30 wherein the plates 30 are surrounded by the border 50. The adjusters 60 are located between the base 20 and the plates 30.

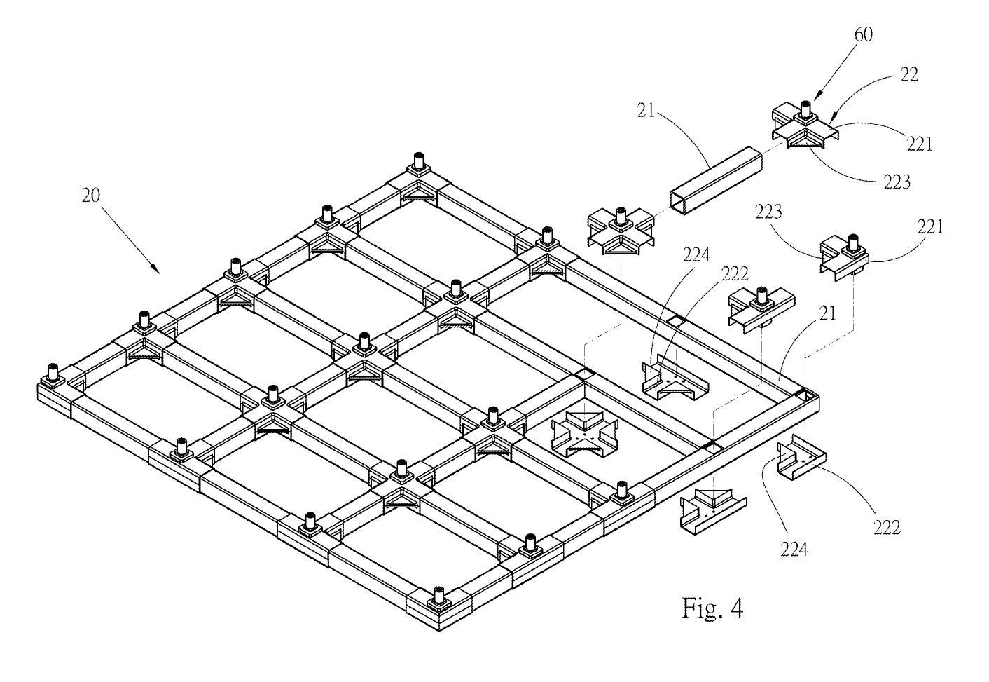

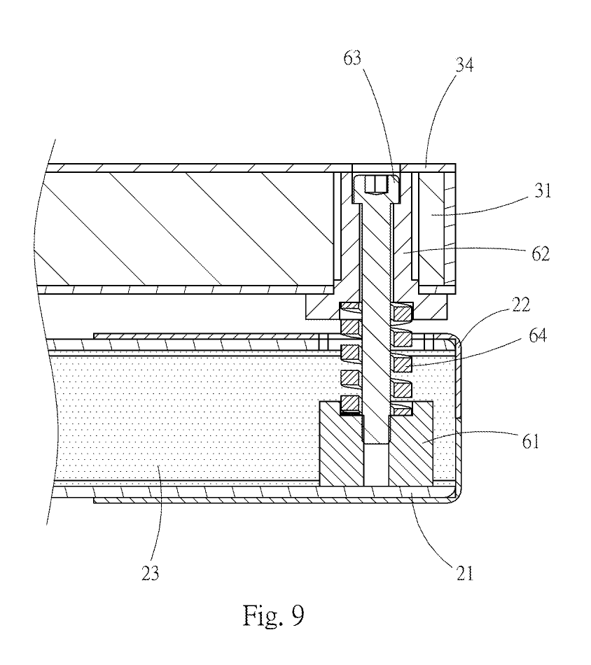

Refer to FIG. 4 and FIG. 9. The base 20 includes a plurality of hollow tubes 21, a plurality of strengthening elements 22 and a foam material 23. The hollow tubes 21 are rectangular formation, and crossed with each other to form a mesh arrangement. Each strengthening element 22 includes a first shell 211 and a second shell 222 assembled with each other to hold the intersections of the hollow tubes 21. Moreover, each strengthening elements 22 further includes a first supporter 223 fixed on the first shell 221, and a second supporter 224 fixed on the second shell 222. The first supporter 223 and the second supporter 224 are in the form of sheet whereby the first supporter 223 can be set against the second supporter 224 to provide a support at the corner of the strengthening element 22 after the assembly of the first shell 211 and the second shell 222. Accordingly, the strengthening elements 22 hold the intersections of the hollow tubes 21 through the assembly of the first shell 211 and the second shell 222 wherein the corner of the strengthening element 22 is supported by the first supporter 223 and the second supporter 224 such that the strength of the intersections of the hollow tubes 21 is enhanced. The foam material 23 is fulfilled with the hollow tubes 21 (shown in FIG. 9).

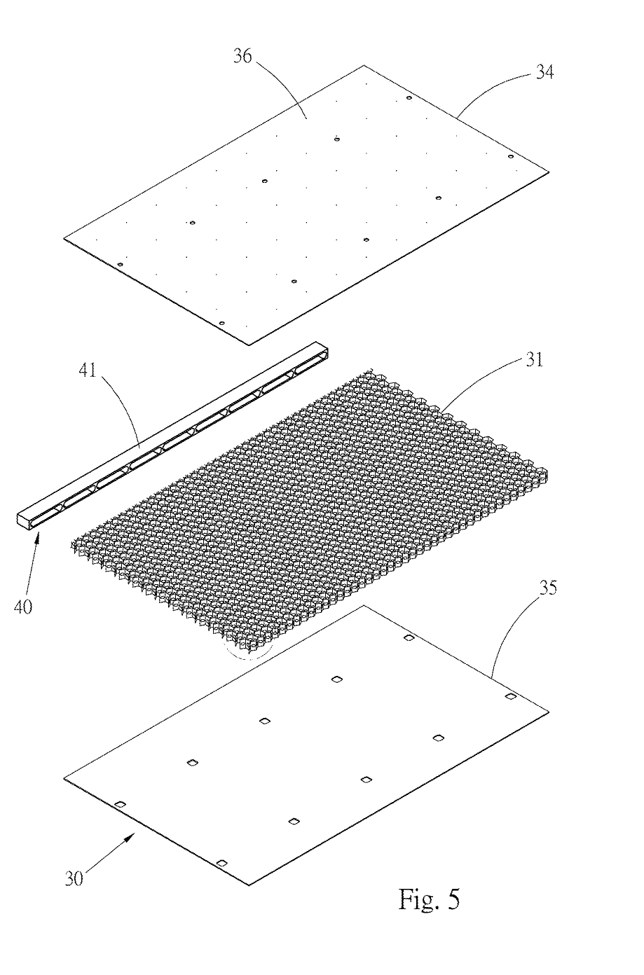

Refer to FIG. 3, FIG. 5 and FIG. 6. The plates 30 are adjacent with each other and disposed on the base 20. Each plate 30 includes a body 31, a plurality of cells 32, a plurality of first openings 33, a front panel 34, a rear panel 35 and a plurality of voids 36. The first openings 33 are configured on the walls of the cells 32 to communicate with the cells 32. The front panel 34 and the rear panel 35 are adhered on two opposite sides of the body 31 to be secured on the cells 32 wherein the voids 36 configured on the front panel 34 communicate with the cells 32.

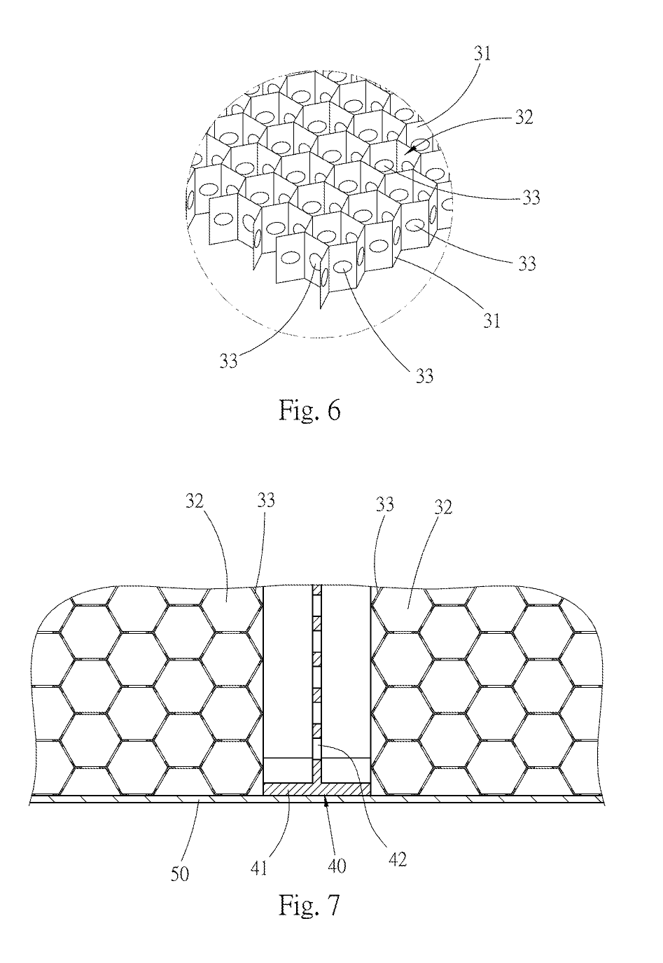

Refer to FIG. 5 and FIG. 7. The connector 40 includes a connecting division 41 and a plurality of second openings 42 wherein the connecting division 41 is arranged between the plates 30, and the second openings 42 are configured on the connecting division 41 and communicated with the first openings 33.

Refer to FIG. 3 and FIG. 7. The border 50 surrounding the plates 30 and between the front panel 34 and the rear panel 35 is composed of four edges to seal the first openings 33.

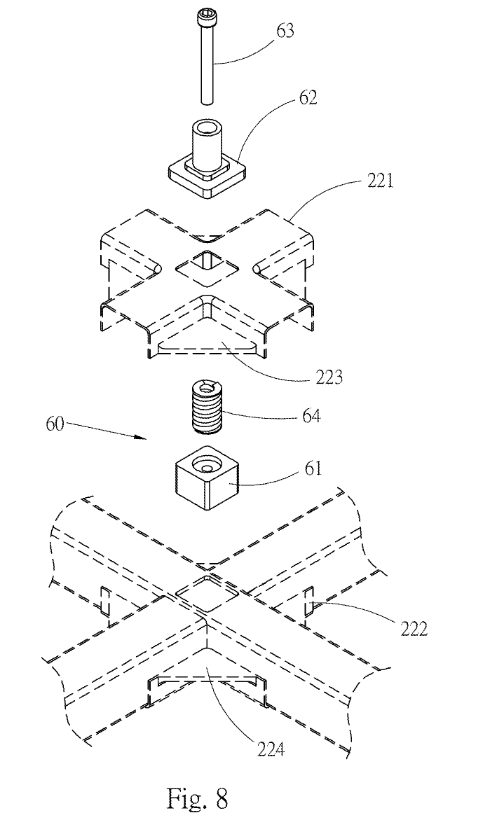

Refer to FIG. 4, FIG. 8 and FIG. 9. Each adjuster 60 includes a fixture 61, a mover 62, an adjusting element 63 and an elastic element 64. The fixture 61 is a block with screw hole and secured within the hollow tubes 21 of the base 20 through the screws (not shown). The mover 62 is positioned through the body 31 and connected with the front panel 34 wherein the adjusting element 63 is a bolt locked within the hole of the mover 62 and the screw hole of the fixture 61. The elastic element 64 is a helical spring holding the adjusting element 63 and set between the fixture 61 and the mover 62.

In the embodiment of the vacuum absorbing platform 10, the cells 32 are communicated with each other through the first openings 33, and the voids 36 are communicated with the cells 32. Accordingly, the absorbing effect is improved to solve the lack of the vacuum degree of the prior art. Although the mechanism of the aspirating is not shown in the embodiment, the exterior aspirator can be connected with the vacuum absorbing platform 10 as illustrated in the prior art. Specifically, the exterior aspirator can be placed laterally and connected with the holes configured on the border 50 to meet the industrial requirement.

Moreover, the connector 40 is arranged to link the plates 30 in accordance with various size of the vacuum absorbing platform 10, and to direct the air between the plates 30. Besides, the rigidity of the vacuum absorbing platform 10 is raised because of the connector 40.

Furthermore, the distance between the plates 30 and the base 20 can be regulated through the adjuster 60 to provide horizontal correction of the vacuum absorbing platform 10. Also, the elastic element 64 is provided to prevent the adjusting element 63 from being loosened thereby increasing the strength.

In addition to the foam material increasing the shock absorption, the strengthening elements 22 holding the intersections of the hollow tubes 21 are provided to enhance the strength of the vacuum absorbing platform 10.

What is claimed is:

1. A vacuum absorbing platform, comprising: contiguous
a base,
a plate unit, disposed on the base and comprising a body, a front panel and a rear panel wherein the body comprises a plurality of cells contiguous with each other and a plurality of first openings configured on the walls of the cells; the front panel is secured on one side of the body to seal the cells and comprises a plurality of voids communicate with the cells respectively; the rear panel is secured on the other side of the body to seal the cells; and
a plurality of adjusters, located between the base and the plate unit to regulate the distance therebetween.

2. The vacuum absorbing platform as claimed in claim 1, wherein the plate unit comprises two plates connected with each other.

3. The vacuum absorbing platform as claimed in claim 2, further comprising a connector with a connecting division and a plurality of second openings wherein the connecting division is arranged between the plates, and the second openings are configured on the connecting division and communicated with the first openings.

4. The vacuum absorbing platform as claimed in claim 1, further comprising a border surrounding the plate unit.

5. The vacuum absorbing platform as claimed in claim 1, wherein each of the adjusters comprises a fixture secured on the base, a mover positioned through the body and connected with the front panel, an adjusting element connected between the fixture and the mover, and an elastic element set between the fixture and the mover.

6. The vacuum absorbing platform as claimed in claim 5, wherein the base comprises a plurality of hollow tubes crossed with each other, and the fixtures are secured within the hollow tubes.

7. The vacuum absorbing platform as claimed in claim 6, wherein the base comprises a foam material fulfilled with the hollow tubes.

8. The vacuum absorbing platform as claimed in claim 6, wherein the base comprises a plurality of strengthening elements secured on the intersections of the hollow tubes.

9. The vacuum absorbing platform as claimed in claim 8, wherein each of the strengthening elements comprises a first shell and a second shell assembled with each other to hold the intersection of the hollow tubes.

10. The vacuum absorbing platform as claimed in claim 9, wherein each of the strengthening elements comprises a first supporter fixed on the first shell, and a second supporter fixed on the second shell; the first supporter is set against the second supporter.
